(19) United States
(12) Patent Application Publication
(10) Pub. No.: US 2014/0366853 A1
(43) Pub. Date: Dec. 18, 2014

(54) EGR CONTROLLER FOR INTERNAL COMBUSTION ENGINE

(71) Applicant: DENSO CORPORATION, Kariya-city (JP)

(72) Inventor: Hideaki ICHIHARA, Obu-city (JP)

(73) Assignee: DENSO CORPORATION, Kariya-city (JP)

(21) Appl. No.: 14/299,519

(22) Filed: Jun. 9, 2014

(30) Foreign Application Priority Data
Jun. 12, 2013 (JP) 2013-123431

(51) Int. Cl. F02M 25/07

(52) U.S. Cl. CPC F02M 25/07
USPC 123/568.11

(57) ABSTRACT

While an engine is at idling state with an EGR valve fully closed, an EGR controller estimates a leak quantity of an exhaust gas flowing into an intake passage and performs a biasing-force-increase control in which the EGR valve is biased toward a full-close position. When the leak quantity of the exhaust gas is greater than or equal to a specified value, the controller executes an abutting control in which the EGR valve is opened and closed multiple times so that the EGR valve is brought into contact with a valve seat multiple times after the engine is shut down.

### CROSS-REFERENCE TO RELATED APPLICATION

This application is based on Japanese Patent Application No. 2013-123431 filed on Jun. 12, 2013, the disclosure of which is incorporated herein by reference.

### TECHNICAL FIELD

The present disclosure relates to an EGR controller for an internal combustion engine provided with an EGR valve. The EGR valve adjusts a quantity of recirculated exhaust gas flowing into a cylinder. The EGR controller controls an opening degree of the EGR valve.

### BACKGROUND

An EGR apparatus recirculates a part of an exhaust gas into an intake passage of an internal combustion engine in order to improve fuel economy and reduce exhaust emission. The EGR apparatus has an EGR valve which adjusts a quantity of recirculated exhaust gas flowing into a cylinder. As the EGR gas quantity is more increased, the intake air (fresh air) quantity introduced into a cylinder is more decreased, so that a combustion condition of air-fuel mixture may deteriorates.

JP-U-S53-32243A shows an ignition control system in which an ignition timing is advanced when an EGR apparatus is operated or when an engine is at idling state in order to improve a fuel combustion in an internal combustion engine.

When an EGR valve is worn away or a foreign matter is engaged between a valve body and a valve seat of the EGR valve, a valve clearance between the valve body and the valve seat is enlarged at a full-close position, which may increase a leakage quantity of the EGR gas flowing into an intake passage when the EGR valve is fully closed. Especially, when the intake air quantity is relatively small at idling state, the EGR gas quantity becomes excessive due to the EGR gas leakage, which may deteriorate the fuel combustion condition.

When the EGR gas leakage occurs, it is likely that the intake air quantity is decreased relative to a required output of the engine and the fuel combustion condition is more deteriorated due to the EGR gas leakage even though the ignition timing is advanced like the above ignition control system.

### SUMMARY

It is an object of the present disclosure to provide an EGR controller which is able to reduce an EGR gas leakage from an EGR valve so that a deterioration in fuel combustion condition is restricted.

According to the present disclosure, an EGR controller is applied to an internal combustion engine equipped with an EGR valve adjusting a quantity of an exhaust gas recirculating into an intake passage. The EGR controller has a leak-quantity estimating portion estimating a leak quantity of the exhaust gas flowing into an intake passage while the EGR valve is fully closed, and a biasing-force-increase control portion increasing a valve-closing biasing-force applied to the EGR valve in a valve-closing direction.

Further, since the valve-closing biasing-force is increased according to the leak quantity of the exhaust gas, the biasing-force-increase control can be performed with an appropriate biasing force. It can be avoided that the valve-closing biasing-force becomes excessive.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to an embodiment;

FIG. 2 is a schematic view showing an EGR valve;

FIG. 3 is a flow chart showing a processing of an EGR control routine;

FIG. 4 is a flow chart showing a processing of a correction-duty signal computing routine;

FIG. 5 is a chart conceptually showing a map which defines a relation between an EGR gas leak quantity and a differential pressure between an actual intake pressure and a target intake pressure;

FIG. 6 is a chart conceptually showing a map which defines a relation between an EGR gas leak quantity and an engine speed variation;

FIG. 7 is a chart conceptually showing a map which defines a relation between an EGR gas leak quantity and an ISC quantity;

FIG. 8 is a chart conceptually showing a map which defines a relation between an EGR gas leak quantity and an output of an EGR gas sensor;

FIG. 9 is a chart conceptually showing a map which defines a relation between an EGR gas leak quantity and a correction-duty signal; and

FIG. 10 is a time chart for explaining an abutting control.

### DETAILED DESCRIPTION

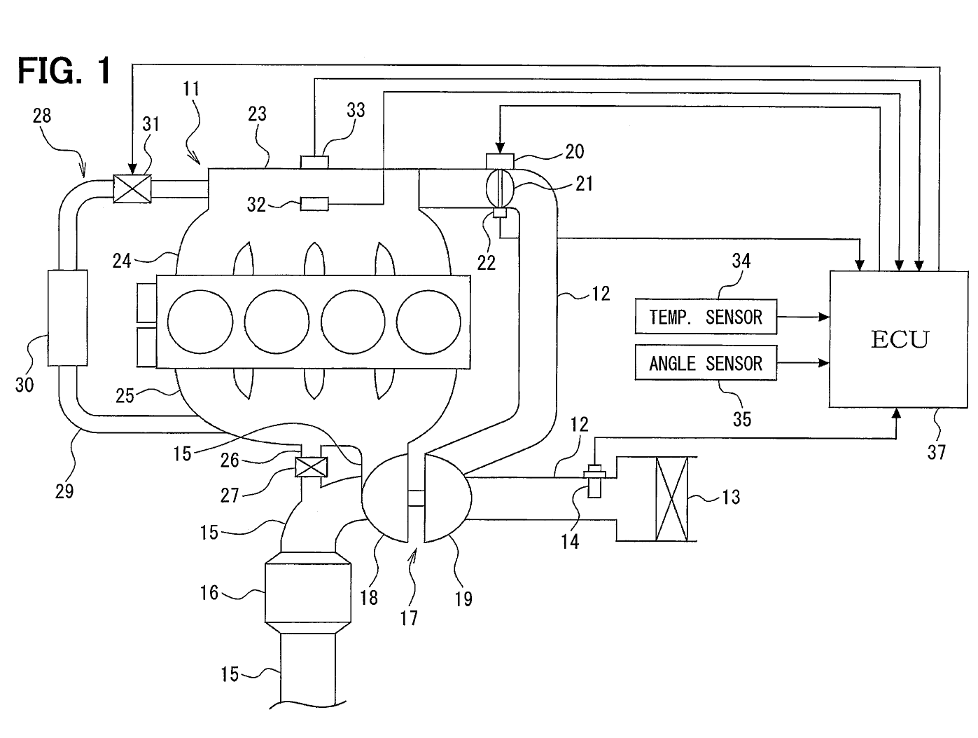

An embodiment will be described hereinafter. First, referring to FIG. 1, an engine control system is schematically explained. An air cleaner 13 is arranged upstream of an intake pipe 12 (intake passage) of an internal combustion engine 11. An airflow meter 14 detecting an intake air quantity is provided downstream of the air cleaner 13. An exhaust pipe 15 (exhaust passage) of the engine 11 is provided with a three-way catalyst 16 which reduces CO, HC, NOx, and the like contained in exhaust gas.

The engine 11 is provided with a turbocharger 17. The turbocharger 17 includes an exhaust gas turbine 18 arranged upstream of the catalyst 16 in the exhaust pipe 15 and a compressor 19 arranged downstream of the airflow meter 14 in the intake pipe 12. This turbocharger 17 has well known configuration which supercharges the intake air into the combustion chamber.

A throttle valve 21 driven by a DC-motor 20 and a throttle position sensor 22 detecting a throttle position (throttle opening degree) are provided downstream of the compressor 19.

An intercooler (not shown) and a surge tank 23 is provided downstream of the throttle valve 21. The intercooler may be arranged upstream of the surge tank 23 and the throttle valve 21. An intake manifold 24 (intake passage) which introduces air into each cylinder of the engine 11 is provided downstream of the surge tank 23, and a fuel injector (not shown) which injects fuel is provided for each cylinder. A spark plug (not shown) is mounted on a cylinder head of the engine 11 corresponding to each cylinder to ignite air-fuel mixture in each cylinder.

An exhaust manifold 25 (exhaust passage) is connected to each exhaust port of the cylinder. A confluent portion of the exhaust manifold 25 is connected to the exhaust pipe 15 upstream of the exhaust gas turbine 18. An exhaust bypass passage 26 bypassing the exhaust gas turbine 18 is connected to the exhaust pipe 15. A waste gate valve 27 is disposed in the exhaust bypass passage 26 to open/close the exhaust bypass passage 26.

The engine 11 is provided with an EGR apparatus 28 which recirculates a part of exhaust gas flowing through an exhaust passage (exhaust manifold 25 or exhaust pipe 15) upstream of the catalyst 16 into an intake passage (surge tank 23 or intake manifold 24) downstream of the throttle valve 21. Such EGR apparatus 28 is referred to as High Pressure Loop (HPL) EGR apparatus. The EGR apparatus 28 has an EGR pipe 29 connecting the exhaust passage upstream of the exhaust gas turbine 18 and the intake passage downstream of the throttle valve 21. An EGR cooler 30 for cooling the EGR gas and an EGR valve 31 for adjusting an exhaust gas recirculation quantity (EGR gas quantity) are provided in the EGR pipe 29. An opening degree of the EGR valve 31 is adjusted by a motor (not shown).

Further, the engine 11 is provided with a coolant temperature sensor 34 detecting coolant temperature and a crank angle sensor 35 outputting a pulse signal every when the crank shaft (not shown) rotates a specified crank angle. Based on the output signal of the crank angle sensor 35, a crank angle and an engine speed are detected. Moreover, an EGR gas sensor 32 detecting an EGR gas concentration and an intake pressure sensor 33 detecting an intake pressure are provided to an intake passage (surge tank 23 or intake manifold 24) into which the recirculated EGR gas flows. The EGR gas sensor 32 includes an air-fuel ratio sensor or an oxygen sensor.

The outputs of the above sensors are transmitted to an electronic control unit (ECU) 37. The ECU 37 includes a microcomputer which executes an engine control program stored in a Read Only Memory (ROM) to control a fuel injection quantity, an ignition timing, a throttle position (intake air quantity) and the like.

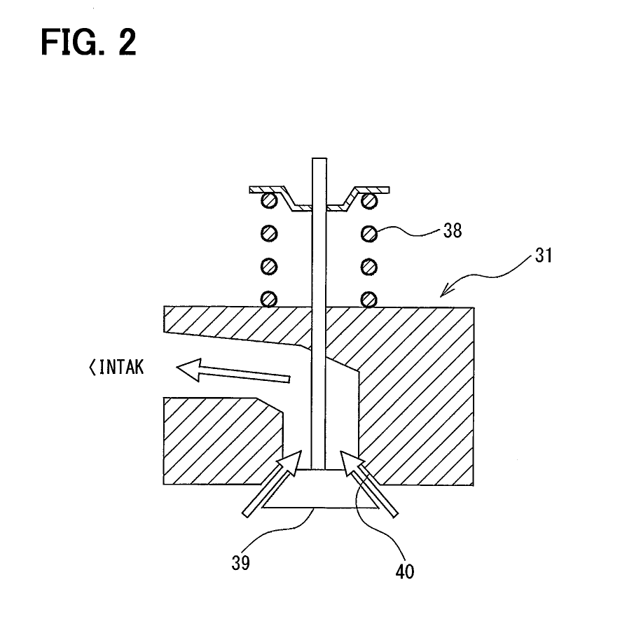

As shown in FIG. 2, the EGR valve 31 is a poppet valve having a valve body 39 and a spring 38. The spring 38 biases the valve body 39 in a valve-closing direction. A DC motor (not shown) drives the valve body 39 in a valve-opening direction against the biasing force of the spring 38. The ECU 37 generates a control duty signal based on which a driving current of the motor is controlled, whereby an opening degree of the EGR valve 31 is adjusted.

In a case that the control duty signal is a positive value, the motor is driven to close the valve body 39 of the EGR valve 31.

In a case that the control duty signal is a negative value, the motor is driven to open the valve body 39 of the EGR valve 31.

In a case that the control duty signal is zero, the driving current applied to the motor becomes zero. The spring 38 biases the valve body 39 in a valve-closing direction. That is, the spring 38 generates a holding force which brings the valve body 39 into a full-close position in which the valve body 39 is in contact with a valve seat 40. Further, when the control duty signal becomes a negative value from zero, the motor drives the valve body 39 in the valve-closing direction so that a biasing force biasing the EGR valve 31 toward the full-close position is increased.

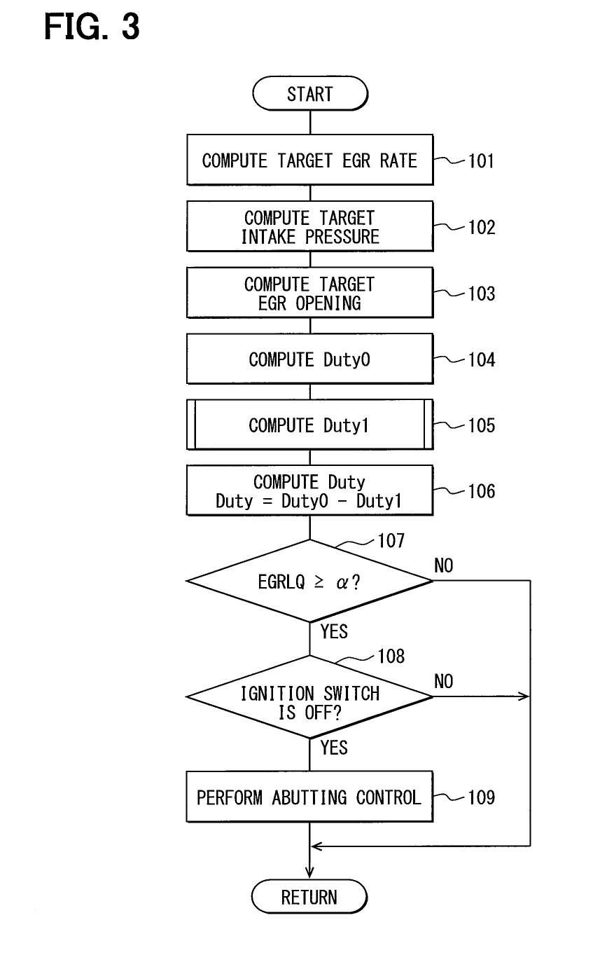

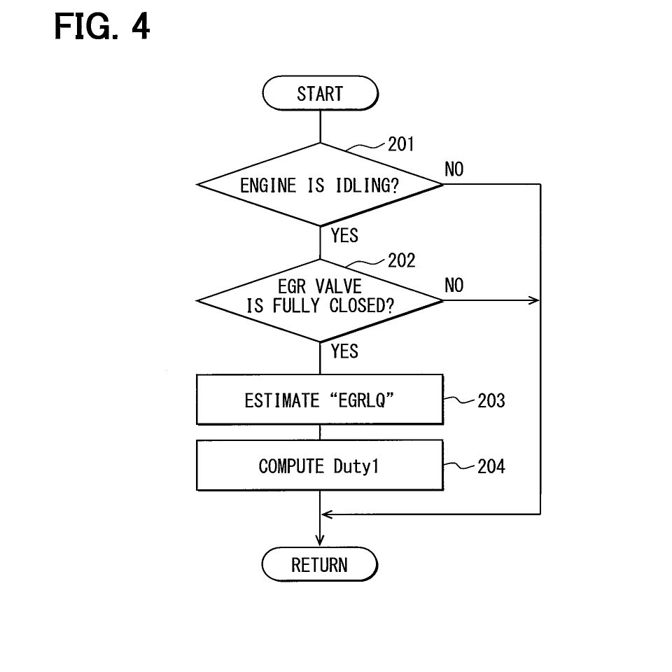

The ECU 37 executes each EGR control routine shown in FIGS. 3 and 4. The ECU 37 computes a target EGR rate based on an operational state of the engine 11. Then, based on the target EGR rate and the target intake air quantity of the engine 11, the ECU 37 computes a target EGR opening. Further, based on the target EGR opening, the ECU 37 computes the control duty signal.

When an EGR valve 31 is worn away or a foreign matter is engaged between a valve body and a valve seat of the EGR valve 31, a valve clearance between the valve body and the valve seat is enlarged at a full-close position, which may increase a leakage quantity of the EGR gas flowing into the intake passage when the EGR valve 31 is fully closed. The leakage quantity of the EGR gas is referred to as “EGRLQ” hereinafter. Especially, when the intake air quantity is relatively small at idling state, the EGR gas quantity becomes excessive due to the EGR gas leakage, which may deteriorate the fuel combustion condition.

According to the present embodiment, while the engine is at idling state with the EGR valve 31 fully closed, the ECU 37 estimates the EGRLQ. Based on the EGRLQ, the ECU 37 executes a biasing-force-increase control (BFI control) in which the control duty signal to the EGR valve 31 is corrected in such a manner as to increase a valve-closing biasing-force (VCBF) applied to the valve body 39 in a valve-closing direction toward the valve seat 40. When the EGRLQ is increased due to an abrasion of the EGR valve 31 or a foreign matter, the ECU 37 executes the BFI control so that the clearance between the valve body 39 and the valve seat 40 is reduced. As the result, the EGRLQ can be decreased.

Furthermore, when the EGRLQ is greater than or equal to a specified value α, the ECU 37 executes an abutting control in which the valve body 39 is opened and closed multiple times so that the valve body 39 is brought into contact with the valve seat 40 multiple times after the engine 11 is shut down, for example, after an ignition switch is turned off. Thereby, even when a foreign matter is engaged between the valve body 39 and the valve seat 40, the foreign matter can be removed therefrom.

The EGRLQ is estimated based on a differential pressure between an actual intake pressure detected by the intake pressure sensor 33 and a target intake pressure. As the EGRLQ becomes larger, the actual intake pressure becomes higher. Also the differential pressure between the actual intake pressure and the target intake pressure becomes larger. Thus, the differential pressure can be a parameter well reflecting the EGRLQ. Based on the differential pressure, the EGRLQ can be estimated with high accuracy. In this case, the EGR gas sensor 32 may not be provided.

Alternatively, the EGRLQ may be estimated based on a variation in engine speed (for example, a standard deviation of an engine speed). As the EGRLQ becomes larger, the fuel combustion condition more deteriorates to increase the variation in engine speed. Thus, the speed variation of the engine 11 can be a parameter well reflecting the EGRLQ. Based on the speed variation of the engine 11, the EGRLQ can be estimated with high accuracy. In this case, the EGR gas sensor 32 may not be provided.

When the engine 11 is idling, an idle-speed-control (ISC) is performed. In the ISC, an ignition timing and an intake air quantity are corrected so that the engine speed agrees with the target engine speed. Based on the ISC quantity (correction quantity of the ignition timing and the intake air quantity), the EGRLQ may be estimated. As the EGRLQ becomes larger, the idle speed becomes more unstable and the ISC quantity becomes larger. Thus, the ISC quantity can be a parameter well reflecting the EGRLQ. Based on the ISC quantity, the EGRLQ can be estimated with high accuracy. In this case, the EGR gas sensor 32 may not be provided.

Moreover, based on the EGR gas concentration detected by the EGR gas sensor 32, the EGRLQ can be estimated.

Referring to FIGS. 3 and 4, the processes of each EGR control routine will be described hereinafter. The EGR control routine shown in FIG. 3 is executed at specified intervals while the ECU 37 is ON. In step 101, the ECU 37 computes the target EGR rate based on an operational state of the engine 11, such as an engine speed and a target engine torque, in view of a map or a formula.

Then, in step 102, the ECU 37 computes a target intake pressure of the engine 11 based on the engine speed and the target intake air quantity. The ECU 37 controls the waste gate valve 27 in order to achieve the target intake pressure.

In step 103, the ECU 37 computes a target EGR opening (target opening of the EGR valve 31) based on the target intake air quantity and the target EGR rate in view of a map or a formula. Then, the procedure proceeds to step 104 in which the ECU 37 computes the basic duty signal Duty0 based on the target EGR opening, the engine speed and the target intake pressure in view of a map or a formula. When the target EGR opening is “0”, that is, when the EGR valve 31 is fully closed, the basic duty signal Duty0 is set to “0” in view of the map or the formula. Alternatively, the basic duty signal Duty0 is set to a negative value.

Then, the procedure proceeds to step 105 in which a correction-duty signal computing routine shown in FIG. 4 is executed in order to computed a correction-duty signal Duty1. In step 201, the ECU 37 determines whether the engine is 11 at idling state. When Yes in step 201, the procedure proceeds to step 202 in which the ECU 37 determines whether the EGR valve 31 is fully closed.

When the answer is No in step 201 or 202, the procedure ends. In this case, the correction-duty signal Duty1 is set to “0.”

When the answer is Yes in step 201 and 202, the procedure proceeds to step 203 in which the EGRLQ is estimated.

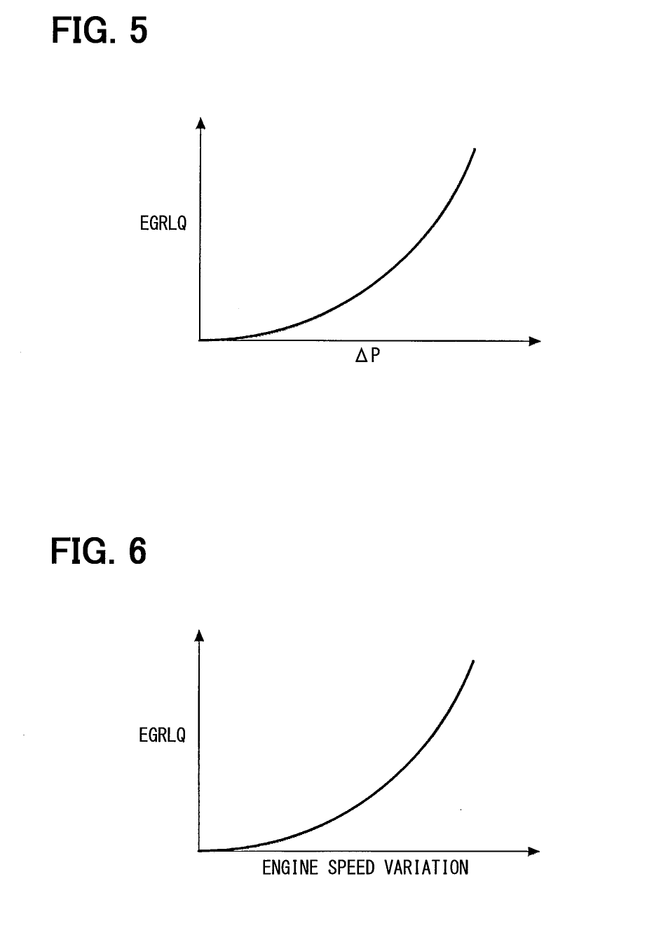

In this case, for example, in view of a map shown in FIG. 5, the EGRLQ is computed according to a differential pressure AP between the actual intake pressure and the target intake pressure. As the EGRLQ becomes larger, the actual intake pressure becomes higher. Also the differential pressure AP becomes larger. Thus, in the map shown in FIG. 5, as the differential pressure AP becomes larger, the EGRLQ is set larger.

Alternatively, in view of a map shown in FIG. 6, the EGRLQ can be computed according to a variation of an engine speed. As the EGRLQ becomes larger, the fuel combustion condition more deteriorates to increase the variation in engine speed. Thus, in the map shown in FIG. 6, as the engine speed variation becomes larger, the EGRLQ is set larger.

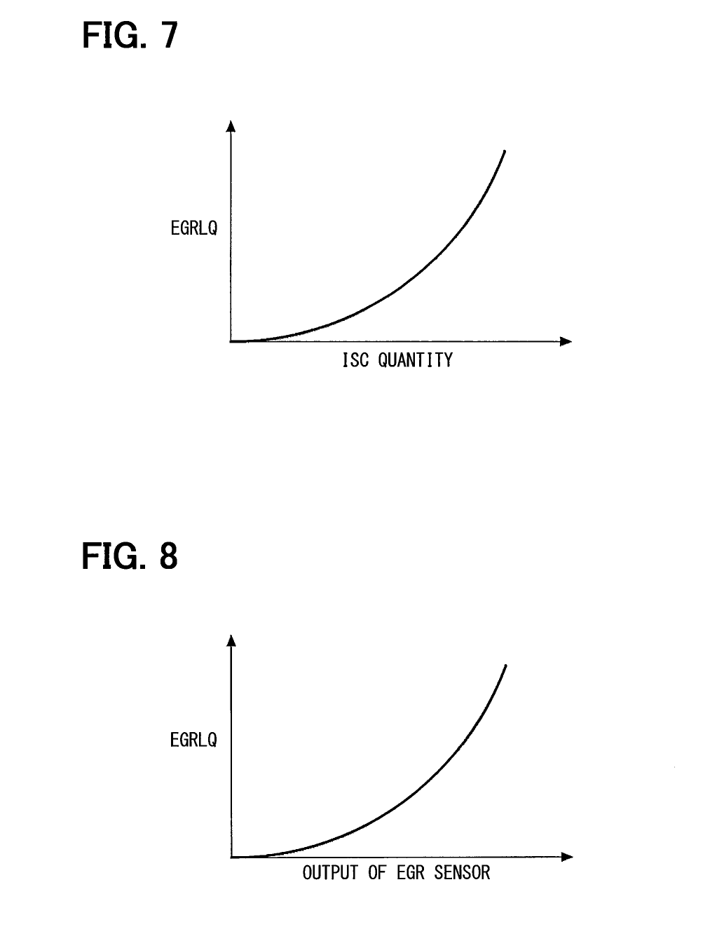

Alternatively, in view of a map shown in FIG. 7, the EGRLQ can be computed according to the ISC quantity. As the EGRLQ becomes larger, the idle speed becomes more unstable and the ISC quantity becomes larger. Thus, in the map shown in FIG. 7, as the ISC quantity becomes larger, the EGRLQ is set larger.

Alternatively, in view of a map shown in FIG. 8, the EGRLQ can be computed according to the output of the EGR gas sensor 32, which corresponds to the EGR gas concentration. In the map shown in FIG. 8, as the output of the EGR gas sensor 32 becomes larger, the EGRLQ is set larger.

Any one of the maps shown in FIGS. 5 to 8 is previously formed based on experimental data and design data, and is stored in the ROM of the ECU 37. The process in step 203 corresponds to a leak-quantity estimating portion.

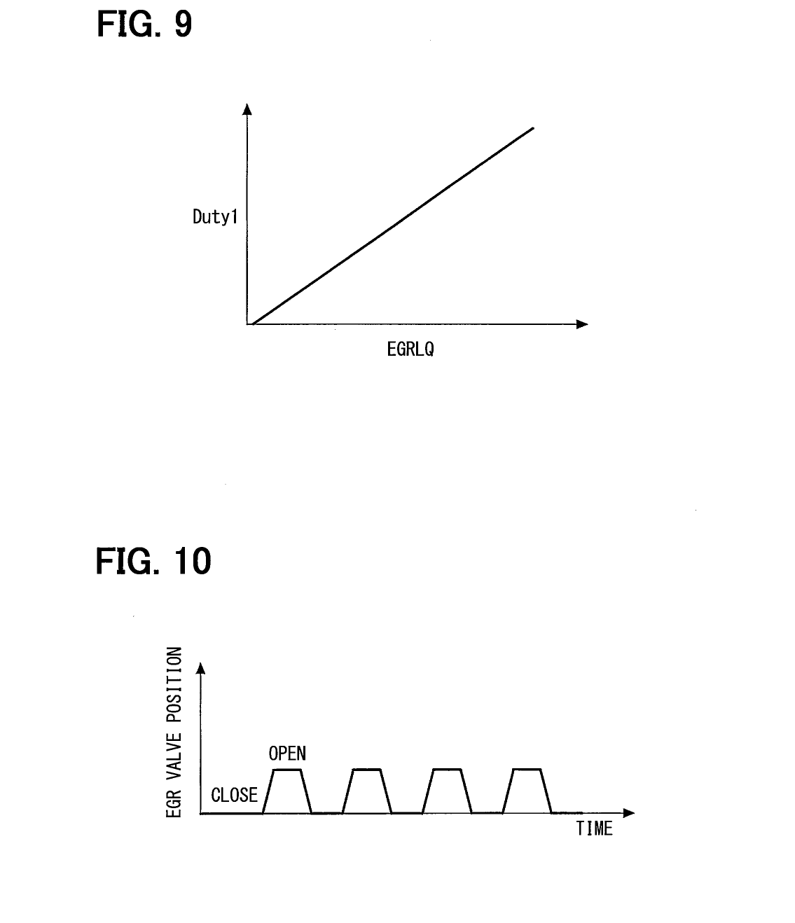

Then, the procedure proceeds to step 204 in which the ECU 37 computes the correction-duty signal Duty1 according to the EGRLQ in view of a map shown in FIG. 9. The map shown in FIG. 9 defines a relation between the EGRLQ and the correction-duty signal Duty1. As the EGRLQ becomes larger, the correction-duty signal Duty1 becomes larger to increase the VCBF. The map is previously formed based on experimental data and design data, and is stored in the ROM of the ECU 37.

After the EGRLQ is estimated and the correction-duty signal Duty1 is computed, the procedure proceeds to step 106 in which a final control duty signal Duty is obtained according to a following formula.

Duty=Duty0−Duty1

As above, while the engine 11 is at idling state, the ECU 37 estimates the EGRLQ. Based on the EGRLQ, the ECU 37 executes the biasing-force-increase control (BFI control) in which the control duty signal to the EGR valve 31 is corrected in such a manner as to increase the valve-closing biasing-force (VCBF) applied to the valve body 39 in a valve-closing direction toward the valve seat 40. The processes in steps 104 and 105 correspond to a biasing-force-increase control portion. Then, the procedure proceeds to step 107 in which the ECU 37 determines whether the EGRLQ is greater than or equal to a specified value α. When the answer is No in step 107, the procedure ends.

When the answer is Yes in step 107, the procedure proceeds to step 108 in which the ECU 37 determines whether an ignition switch is OFF. When the answer is No in step 108, the ECU 37 determines that the engine 11 is running to end the routine.

When the answer is Yes in step 108, the procedure proceeds to step 109 in which the abutting control is performed. In the abutting control, as shown in FIG. 10, the valve body 39 is opened and closed multiple times so that the valve body 39 is brought into contact with the valve seat 40 multiple times at regular intervals after the engine 11 is shut down. The processes in steps 107 to 109 correspond to an abutting control portion.

As above, while the engine 11 is at idling state, the ECU 37 estimates the EGRLQ. Based on the EGRLQ, the ECU 37 executes the biasing-force-increase control (BFI control) in which the control duty signal to the EGR valve 31 is corrected in such a manner as to increase the valve-closing biasing-force (VCBF) applied to the valve body 39 in a valve-closing direction toward the valve seat 40. When the EGRLQ is increased due to an abrasion of the EGR valve 31 or a foreign matter, the ECU 37 executes the BFI control so that the clearance between the valve body 39 and the valve seat 40 is reduced. As the result, the EGRLQ can be decreased. It can be restricted that the fuel combustion condition is deteriorated due to the EGR gas leakage and the idling condition is deteriorated. Further, the VCBF to the EGR valve 31 is increased according to the EGRLQ, whereby the BFI control can be performed with an appropriate biasing force. It can be avoided that the VCBF becomes excessive.

Furthermore, according to the present embodiment, when the EGRLQ is greater than or equal to a specified value α, the ECU 37 executes an abutting control in which the EGR valve 31 is opened and closed multiple times so that the valve body 39 is brought into contact with the valve seat 40 multiple times after the engine 11 is shut down. Thereby, even when a foreign matter is engaged between a valve body 39 and a valve seat 40, the foreign matter can be removed therefrom.

In the above embodiment, while the engine is at idling state, the BFI control is performed. However, even when the engine is not at idling state, the BFI control may be performed in a case that the EGR valve 31 is fully closed.

In the above embodiment, the EGRLQ is estimated based on any one of the differential pressure AP between the actual intake pressure and the target intake pressure, the engine speed variation, the ISC quantity and the output of the EGR gas sensor 32. However, the EGRLQ may be estimated based on two or more of the differential pressure AP, the engine speed variation, the ISC quantity and the output of the EGR gas sensor 32.

The EGR valve 31 is not limited to a poppet valve. The EGR valve 31 may be a butterfly valve or other type valve.

The EGR apparatus 28 is not limited to the HPL type apparatus. The exhaust gas may be recirculated from downstream of the exhaust turbine in the exhaust pipe to downstream of the throttle valve in the intake pipe. Alternatively, the present disclosure can be applied to an engine provided with a low-pressure-loop (LPL) type EGR apparatus in which the exhaust gas is recirculated from downstream of an exhaust turbine in the exhaust pipe to upstream of a compressor in the intake pipe.

The present disclosure can be applied to an engine provided with a mechanical supercharger or an electrical supercharger.

Also, the present disclosure can be applied to an engine having no supercharger.

What is claimed is:

1. An EGR controller for an internal combustion engine equipped with an EGR valve adjusting a quantity of an exhaust gas recirculating into an intake passage, the EGR controller comprising:
a leak-quantity estimating portion estimating a leak quantity of the exhaust gas flowing into an intake passage while the EGR valve is fully closed; and
a biasing-force-increase control portion increasing a valve-closing biasing-force applied to the EGR valve in a valve-closing direction.

2. An EGR controller for an internal combustion engine according to claim 1, further comprising:
an abutting control portion performing an abutting control in which the EGR valve is opened and closed multiple times so that the EGR valve is brought into contact with a valve seat multiple times after the engine is shut down, when the leak quantity of the exhaust gas is greater than or equal to a specified value.

3. An EGR controller for an internal combustion engine according to claim 1, wherein
the leak-quantity estimating portion estimates the leak quantity of the exhaust gas based on a differential pressure between an actual intake pressure and a target intake pressure in the intake passage.

4. An EGR controller for an internal combustion engine according to claim 1, wherein
the leak-quantity estimating portion estimates the leak quantity of the exhaust gas based on a speed variation of the internal combustion engine.

5. An EGR controller for an internal combustion engine according to claim 1, wherein
the leak-quantity estimating portion estimates the leak quantity of the exhaust gas based on a control quantity in an idle speed control of the internal combustion engine.

6. An EGR controller for an internal combustion engine according to claim 1, further comprising:
an EGR gas sensor detecting an exhaust gas concentration in the intake passage, wherein
the leak-quantity estimating portion estimates the leak quantity of the exhaust gas based on an output of the EGR gas sensor.
